(19) United States
(12) Patent Application Publication
(10) Pub. No.: US 2014/0329036 A1
(43) Pub. Date: Nov. 6, 2014

(54) COVER TAPE FOR CARRIER TAPE

(71) Applicants: INSCON TECH CO., LTD., Gyeonggi-do (KR); SOLOE TECH CO., LTD., Gyeonggi-do (KR); DAEWON SEMICONDUCTOR PACKAGING INDUSTRIAL CO., LTD, Gyeonggi-do (KR)

(72) Inventors: Kwang Suck Suh, Gyeonggi-do (KR); Tae Young Kim, Seoul (KR); Jong Eun Kim, Seoul (KR)

(21) Appl. No.: 14/357,178

(22) PCT Filed: Nov. 8, 2012
(86) PCT No.: PCT/KR2012/009390

§ 371 Date: May 8, 2014

(30) Foreign Application Priority Data
Nov. 8, 2011 (KR) 10-2011-0115782

(51) Int. Cl. C09J 7/02; C09J 125/08; C08K 5/01

(52) U.S. Cl. CPC C09J 7/0203; C08K 5/01; C09J 125/08; C09J 2203/326; C09J 2477/006; C09J 2467/006; C09J 2481/003; C09J 2433/003
USPC 428/35.2; 428/141

(57) ABSTRACT

This invention relates to an antistatic cover tape for a carrier tape, including a sealing layer, wherein the antistatic cover tape has irregularities at a surface portion which comes into contact with an object which is transported by the carrier tape, and the sealing layer is formed only on a portion which does not come into direct contact with an object.

### TECHNICAL FIELD

The present invention relates to a cover tape for use in a tape-and-reel (hereinafter, referred to as a “carrier tape”) for transporting parts such as semiconductor IC (Integrated Circuit) chips, etc. More particularly, the present invention relates to a cover tape, which has irregularities at a surface portion coming into contact with an object which is transported by a carrier tape and in which a sealing layer is not formed on the entire surface of the cover tape but is selectively formed on a necessary region thereof.

### BACKGROUND ART

Semiconductor IC chips are transported in a state of being placed in a transport vessel such as a tape-and-reel (hereinafter, referred to as a “carrier tape”). The carrier tape is used for transport in such a manner that a substrate film formed by a triple extrusion process or a coating process is slit to a predetermined size and then heat and pressure are applied to make pockets having a predetermined size, semiconductor chips are placed in the pockets and covered with a cover tape, and then the carrier tape is wound on a reel.

The carrier tape is mainly manufactured using a triple extrusion process or a coating process to impart antistatic properties. For example, in the case where a carrier tape is made by a triple extrusion process using a styrene-based resin, the middle layer is composed mainly of a styrene-based polymer or an acrylonitrile-butadiene-styrene copolymer, and the skin layer is composed of a styrene-based polymer and carbon black which are mixed so as to exhibit a surface resistance of 10⁴ to 10⁶ ohm/area. Then, the pockets in the carrier tape are formed by heat and pressure.

The cover tape is used by forming a heat sealing type adhesive layer on one surface of a monolayered or two-layered polymer film or by forming a PSA (Pressure Sensitive Adhesive) layer which is attached by pressure. Typically, in the case of a heat sealing type cover tape, the adhesive layer is formed on the entire surface of the film and then the film is slit at a predetermined width, and a PSA cover tape is used in the form of the adhesive layer being formed only at the edge portion to be sealed.

Semiconductor chips are conventionally transported in such a manner that the semiconductor chips are fabricated in the pre-process and the packaged chips are transported in the post-process. In some cases, chips before packaging are cut to form individual chips (bare chips), which are then transported in a state of being contained in the carrier tape.

There are some precautions required for transporting bare chips. Specifically, because bare chips are not packaged, they are very lightweight and thus may be improperly attached to the wall of a transport vessel during handling or transport. Also, if a large amount of static electricity is generated, bare chips may be attached to sites having high static electricity, or are directly damaged by conductive impurities or static electricity.

Furthermore, upon aging testing which is performed in consideration of a situation in which the temperature may increase upon passing the equatorial region or when exposed to sunlight for a long period of time in the course of transport of the chips which are placed in the carrier tape and then sealed with the cover tape, a phenomenon where the cover tape is attached to the carrier tape may occur. This is because the adhesive layer of the conventional cover tape comes into direct contact with the surface of the carrier tape. In the case of a carrier tape for transporting bare chips, the above phenomenon becomes severe because the bare chips are lightweight.

Therefore, the cover tape for use in a carrier tape for transporting not only packaged semiconductor chips but also bare chips should be constructed such that the surface of the cover tape, namely, the adhesive layer having a high probability of attaching bare chips, is not exposed to the upside of the bare chips. Also, the sealing force (or peel strength) of the sealing surface should be higher than that of the conventional cover tape. As such, the conventional heat sealing type cover tape is disadvantageous because the adhesive layer is formed on the entire surface of the cover tape. Moreover, because the PSA cover tape is provided in the form of being attached only under pressure at room temperature, its sealing force is comparatively low and thereby the cover tape may be detached during transport, undesirably scattering the chips.

### DISCLOSURE

### Technical Problem

Accordingly, the present invention has been made keeping in mind the above problems encountered in the related art, and the present invention is intended to provide a novel cover tape for a carrier tape, which has irregularities at a surface portion coming into contact with an object which is transported by a carrier tape and in which an adhesive layer is not formed on the entire surface of an antistatic layer but may exhibit sufficiently high sealing force.

In addition, the present invention is intended to provide a novel cover tape for a carrier tape, wherein when bare chips are placed on the carrier tape and transported, high sealing force or peel strength may be exhibited while excluding a probability of attaching of the lightweight chips to the surface of the cover tape.

The aspects of the present invention are not limited to the foregoing, and the other aspects which are not mentioned herein will be able to be clearly understood to those skilled in the art from the following description.

### Technical Solution

In order to solve the above problems, the present invention provides an antistatic cover tape for a carrier tape, comprising a sealing layer, wherein the antistatic cover tape has irregularities at a surface portion that comes into contact with an object transported by the carrier tape, and the sealing layer is formed only on a portion which does not come into direct contact with the product.

The present invention involves a method for forming an antistatic layer having irregularities on a substrate film wherein an adhesive layer to be disposed on the antistatic layer is formed only on a sealing region.

In the antistatic cover tape according to the present invention, the irregularities of the cover tape are formed by making irregularities having a size of 0.5 to 50 μm on the surface of an adhesion enhancing layer, introducing organic or inorganic particles having a size of about 0.5 to 20 μm to the antistatic layer, or making irregularities having a size of 0.5 to 50 μm on the surface of the adhesion enhancing layer and introducing organic or inorganic particles having a size of about 0.1 to 20 μm to the antistatic layer.

According to the present invention, in the substrate film having irregularities with a size of 0.5 to 50 μm on one surface thereof, the antistatic layer containing a conductive polymer as an effective component may be formed on the surface of the substrate film having irregularities. As such, the antistatic layer may contain fine organic or inorganic particles having a size of 0.1 to 20 μm to thus be imparted with fine irregularities.

In a preferred embodiment of the present invention, the substrate film is a multilayer film comprising polymer films of two or more layers which are laminated, wherein one surface of the substrate film is formed with irregularities having a size of 0.5 to 50 μm; a permanent antistatic layer containing a conductive polymer as an effective component is formed on the surface of the substrate film having irregularities, and contains organic or inorganic particles having an average diameter of 0.1 to 20 μm to form fine irregularities on the surface thereof; and a heat sealing type adhesive layer is formed on the antistatic layer having fine irregularities, wherein the adhesive layer is formed in the range of 10 to 90% of the width of a sealing region, namely, the sealing region ranging from the pocket wall of the carrier tape and the edge of the carrier tape, except for the portion having sprocket holes.

### Advantageous Effects

According to the present invention, a cover tape is profitable because an adhesive layer is formed only on a sealing region, thus obviating the need to form the adhesive layer over an unnecessarily large area. In particular, the adhesive layer which is formed only on a partial region is so-called heat sealing type, and thus adhesion is imparted not by simple pressure but by heat and pressure. After sealing, sealing force or peel strength is high, and thus bare chips in pockets can be effectively prevented from being taken out of the carrier tape during transport. Also, during transport of the bare chips, even when the chips come into contact with the surface of the cover tape, they contact the irregularities, thus reducing the contact area of the bare chips, so that the chips are not attached to the surface of the cover tape.

The technique of the present invention is adapted to a cover tape for a carrier tape having very shallow pockets because it can fundamentally suppress attachment of lightweight chips to the heat sealing layer of the cover tape caused by forming the sealing layer on an unnecessary portion.

Also when using the technique of the present invention, there is no need for an antistatic adhesive layer which is essential for a conventional heat sealing type cover tape, thus generating economic benefits.

### BRIEF DESCRIPTION OF DRAWINGS

FIGS. 1 to 3 are cross-sectional views illustrating a cover tape according to embodiments of the present invention; and

FIGS. 4 and 5 are perspective views illustrating a cover tape for use in a carrier tape, according to the present invention.

### MODE FOR INVENTION

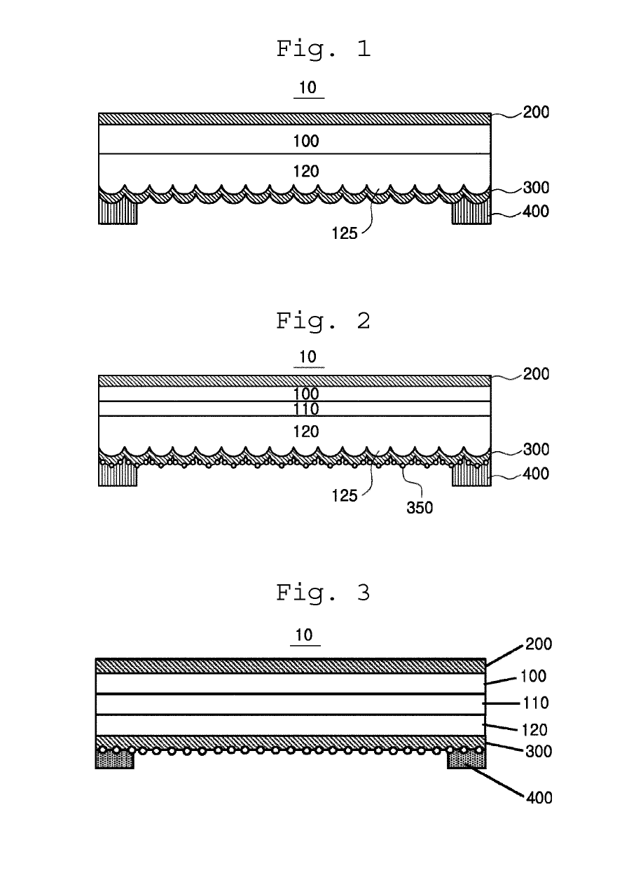

According to the present invention, a cover tape 10 has a layer configuration as illustrated in FIGS. 1 and 2.

As for the layer configuration of the cover tape 10 illustrated in FIG. 1, an adhesion enhancing layer 120 having irregularities 125 with a size of 0.5 to 50 μm is formed on one surface of a monolayer film 100 as a substrate film. A coating film containing a conductive polymer as an effective component is formed on one or both surfaces of the substrate film having the irregularities 125, thus forming a permanent antistatic layer 200, 300. As such, the conductive polymer layer 300 is formed on the surface facing the chips or on the adhesion enhancing layer 120 having irregularities of the substrate film such that the irregularities 125 are externally exposed. Thereafter, a heat sealing type adhesive layer 400 having a predetermined width is formed on the surface of the antistatic layer, thereby manufacturing the cover tape.

As for the cover tape of FIG. 2, an example of a substrate film including two or more layers includes a two-layered film using two films 100, 110. Provided on the film 110 is an adhesion enhancing layer 120 having irregularities 125 with a size of 0.5 to 50 μm. Also, a coating film containing a conductive polymer as an effective component is formed on one or both surfaces of the substrate film, thus forming a permanent antistatic layer 200, 300. Upon forming the antistatic layer 300 on the layer 120 having the irregularities, organic/inorganic particles are mixed together, so that the antistatic layer of the cover tape, containing the conductive polymer as the effective component, has fine irregularities 350 on the surface thereof. Thereafter, a heat sealing type adhesive layer 400 having a predetermined width is formed on the surface of the antistatic layer, resulting in a cover tape.

According to the present invention, the substrate film is configured such that two or more polymer films are stacked. As illustrated in FIG. 1, the two films 100, 110 may be provided in various forms, including a monolayer film comprising a polymer having any one of functional groups such as an ester group, a carbonate group, a styrene group, an amide group, an imide group, an ether group, an olefin group, a sulfone group, etc., a film comprising an alloy or blend of two or more of these functional groups, a multilayer film and so on. Particularly useful is a polyester film having an ester group, and the thickness of the film is not particularly limited.

The adhesion enhancing layer 120 is stacked on the substrate film in order to enhance adhesion, and the material for the adhesion enhancing layer 120 may include a styrene-based resin or copolymer, an amide-based resin or copolymer, or an olefin-based copolymer such as ultra low density polyethylene or ethylenevinylacetate. Although the thickness of the layer 120 is not particularly limited, it is preferably set to 5 to 40 μm taking into consideration the total thickness of the cover tape being 15 to 50 μm. If the thickness of the layer 120 is less than 5 μm, the adhesion enhancement effect becomes insignificant, which is undesirable. In contrast, if the thickness thereof exceeds 40 μm, the heat sealing force becomes too large or the total thickness of the cover tape becomes too high, which is undesirable. Also, the surface of the layer 120 is imparted with irregularities having a size of 0.5 to 50 μm to prevent the bare chips from being attached to the surface of the cover tape and to minimize the generation of static electricity. If the surface roughness of the irregularities is less than 0.5 μm, the contact area with the bare chips may comparatively increase, which is undesirable. In contrast, if the surface roughness thereof exceeds 50 μm, it is difficult to uniformly coat the surface of the layer 120 with the antistatic layer or the sealing layer, which is undesirable.

According to the present invention, the irregularities are preferably formed in the size range of 0.5 to 50 μm. When considering an increase in the contact area and uniform coating with the antistatic layer or the sealing layer, the size of the irregularities of the present invention more preferably falls in the range of about 2 to 20 μm.

The substrate film may have a monolayer film or a film combination of two or more layers as illustrated in FIGS. 1 and 2, and the number of layers may be determined as necessary.

Typically in the case of a single polymer film, even when an adhesive layer is formed only on a partial region, curling in which the film curls in a width direction may occur undesirably. To prevent this, two kinds of different films which are combined may be used. For example, the use of a laminate comprising a polyester film and a nylon film which are stacked may effectively suppress curling.

According to the present invention, because the cover tape should carry semiconductor chips or bare chips, it should be imparted with permanent antistaticity to prevent damage due to static electricity during transport or handling. Such permanent antistaticity is exhibited by applying a coating solution composition containing a conductive polymer as an effective component on the surface of the film, and drying and curing it.

The method of forming the antistatic layer containing the conductive polymer as an effective component is as follows. Specifically, a conductive polymer is mixed with an organic/inorganic binder at an appropriate ratio, added with an additive such as a thickener, a thermal stabilizer, a conductivity enhancer, a leveling agent, an antifoaming agent, etc., and then mixed with a solvent, thus preparing a conductive polymer coating solution composition. This composition is applied on the surface of the film by means of various processes, such as a gravure coating process, a spray coating process, a slot die coating process, a roll coating process, etc., thus forming the antistatic layer.

Useful in the present invention, the conductive polymer is composed of a functional group such as aniline, pyrrole or thiophene, or any conductive polymer modified therefrom may be used, and examples thereof may include polyaniline, polypyrrole, polythiophene and poly(3,4-ethylenedioxythiophene), and derivatives thereof.

As such, to enhance adhesion between the surface of the film and the antistatic layer comprising a conductive polymer, an adhesion enhancing layer or a primer layer is formed on the surface of the film, or interlayer adhesion may be enhanced through corona treatment.

The surface resistance of the antistatic layer containing a conductive polymer as an effective component is 10⁴ to 10¹⁰ ohm/area. The antistatic layer need not necessarily be formed on both surfaces of the film. However, with the goal of effectively controlling static electricity generated from a space between the chips and the cover tape during transport or static electricity occurring from the outside after packaging, the antistatic layer containing a conductive polymer as an effective component is favorably formed on both surfaces of the film.

As mentioned above, the cover tape according to the present invention imparts irregularities to one surface of the substrate film, and thereby the area which comes into contact with the chips is reduced to thus suppress generation of static electricity and prevent attachment of the chips to the cover tape. Also for the same purposes, the cover tape according to the present invention imparts fine irregularities to the surface of the antistatic layer by using inorganic or organic particles having a diameter of 0.1 to 20 μm.

To this end, fine irregularities of the antistatic layer favorably have a protrusion height of about 0.1 to 20 μm. If the protrusion height is less than 0.1 μm, the effects of surface irregularities are insignificant, which is undesirable. In contrast, if the protrusion height is greater than 20 μm, the chips which are vertically moved upon transport may come into contact with the protrusions and may thus be damaged, which is undesirable.

An example of such a structure is described with reference to FIG. 3. As illustrated in FIG. 3, an antistatic layer 300 is formed on an adhesion enhancing layer 120 without the irregularities 125 in the layer configuration of FIG. 2, and particles are introduced to the antistatic layer 300, so that fine irregularities 350 are formed to protrude. As shown in FIG. 3, in the case where fine irregularities 350 are formed to protrude by introducing the particles only to the antistatic layer 300, the size of the particles is preferably set to 0.5 μm or more. In the present invention, the size of the irregularities is preferably set to at least 0.5 μm as mentioned above. As shown in FIG. 2, in the case where the irregularities are formed on the adhesion enhancing layer, the irregularities of the antistatic layer may be formed to 0.1 μm or more. However, in the case where the antistatic layer alone has the irregularities by introducing the particles thereto, the use of the particles having 0.5 μm or more is preferable to provide irregularities having 0.5 μm or more.

The size of the irregularities is more preferably set to about 2 to 20 μm considering an increase in the contact area, as mentioned above.

Useful in the present composition, organic or inorganic particles comprise organic beads including styrene and acryl, or inorganic particles including silica, titanium oxide, talc, calcium carbonate, alumina, zirconia, etc. These particles are used alone or in mixtures of one or more kinds. The organic or inorganic particles are preferably used in an amount of 1 to 100 parts by weight based on 100 parts by weight of the conductive polymer. If the amount of the particles is less than 1 part by weight, it is difficult to sufficiently form the irregularities on the antistatic layer. In contrast, if the amount thereof exceeds 100 parts by weight, it is difficult to disperse the particles, making it difficult to form uniform irregularities.

The antistatic layer containing the conductive polymer as the effective component is applied on the substrate film using a typical coating process, for example, gravure, reverse gravure, spraying, offset, slot die, spin coating, inkjet, screen and other coating processes. However, in the case where formation of the antistatic layer on the entire surface of the cover tape is not desired, the antistatic layer may be effectively provided in a mesh shape using a conductive polymer by a gravure coating process. Specifically, grooves having a predetermined width may be recessed on the surface of a gravure roll, and the composition composed of a conductive polymer may be placed in the grooves and then transferred to the surface of a film, thus forming a mesh-shaped antistatic layer on the surface of the film. In this case, the portion corresponding to the antistatic layer may be provided in any shape such as a mesh shape, a rectangular shape, a triangular shape, etc.

According to the present invention, the sealing layer is a heat sealing type adhesive layer which is adhered by heat and pressure, and thus the sealing layer is preferably formed on the antistatic layer. The sealing layer is composed mainly of an adhesive which enables the layer to be easily attached to the carrier tape when subjected to heat and pressure, and the adhesive may include urethane-, acryl- and silicone-based adhesives, EVA-based adhesive or rubber-based adhesive. Examples of the rubber-based adhesive include natural rubber, butadiene rubber, ionomer rubber, styrene-butadiene (SBR), styrene-isoprene, styrene-butadiene-styrene (SBS), styrene-isoprene-styrene (SIS), styrene-ethylene-butylene-styrene (SEBS). Preferably useful is a styrene-based copolymer comprising styrene, butadiene, ethylene, butylene, acrylonitrile, etc.

Also to further enhance sealing force or peel strength of the sealing layer composed of rubber-based adhesive, a tackifier having 8 or less carbon atoms may be added in an amount of 10 parts by weight or less based on 100 parts by weight of the styrene-based copolymer. If the amount of the tackifier is greater than 10 parts by weight, sealing force becomes too high or severe changes in peel strength upon aging testing may occur.

Also to improve aging properties of the sealing layer comprising the rubber-based adhesive, organic or inorganic particles may be used in an amount of 0.5 to 10 parts by weight based on 100 parts by weight of the rubber-based adhesive. Examples of the organic or inorganic particles include crosslinked styrene or acrylic microbeads, silica, titanium oxide, talc, calcium carbonate, alumina, and zirconia particles. If the amount of the organic or inorganic particles is less than 0.5 parts by weight based on 100 parts by weight of the rubber-based adhesive, sealing force may excessively increase after aging testing. In contrast, if the amount thereof is greater than 10 parts by weight, peel strength may excessively decrease, which is undesirable.

The cover tape according to the present invention is manufactured by forming the antistatic layer including the conductive polymer and then forming the sealing layer thereon. Thus, the sealing layer should have good adhesion to the carrier tape and also to the antistatic layer including the conductive polymer. To this end, in the present invention, the styrene-based copolymer is added with an adhesive functional group such as maleic acid or maleic anhydride, so that adhesion to the antistatic layer including the conductive polymer is made high.

The rubber-based adhesive is prepared by being dissolved in a proper solvent, namely, an organic solvent such as toluene, ethylacetate, methyletherketone, acetone, methylisobutylketone, xylene, etc. As such, an additive such as a wetting agent, a leveling agent, a thickener or the like may be added in a small amount, as necessary.

The solid content of this solution is not particularly limited, and is selected considering the coating thickness of the adhesive layer and the preparation process and conditions. The kind and the amount of the other additives are not particularly limited, and known methods applied to conventional coating techniques may be performed.

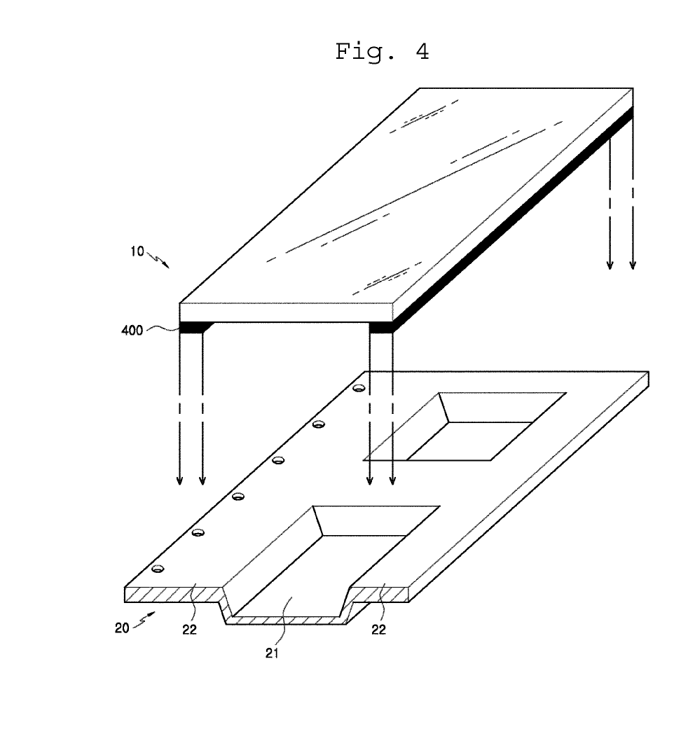

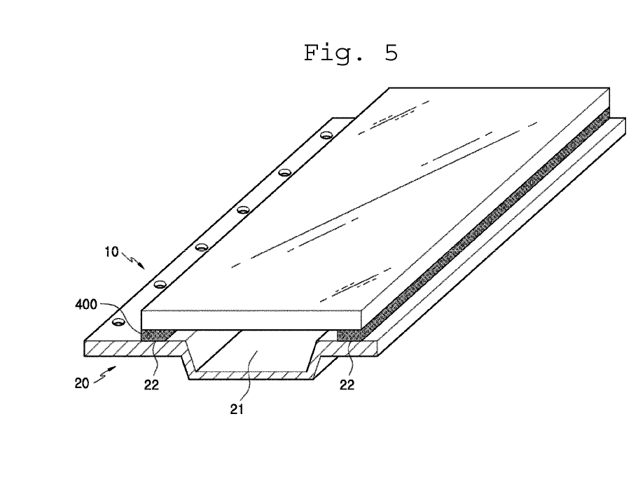

The sealing layer 400 is not formed on the entire surface of the antistatic layer but is formed to have a predetermined width as illustrated in FIGS. 4 and 5. In the present invention, the sealing layer is formed on a portion that does not come into contact with the object in the carrier tape. The procedure of bonding the cover tape 10 according to the present invention onto a carrier vessel 20 comprising pockets 21 for receiving objects and a sealing part 22 to which the sealing layer 400 is attached is illustrated in FIG. 4, and the bonded state is illustrated in FIG. 5. Preferably, the width of the sealing layer falls in the range of 10 to 90% of the width of the sealing region of the carrier tape ranging from the pocket wall of the embossed carrier tape to the edge of the carrier tape, except for the portion having sprocket holes. The reason why a predetermined width is defined between the pocket wall of the carrier tape and the sprocket holes is to completely exclude attachment potential of the bare chips to the heat sealing layer due to shaking during transport when the adhesive layer of the heat sealing layer is positioned in the pockets.

The sealing layer may be formed using a conventional coating process, and the sealing layer having a predetermined width may be formed by a coating process such as gravure, reverse gravure, slot die, screen printing, offset printing or other coating processes.

The thickness of the sealing layer is appropriately set to 1 to 20 μm. If the thickness of the sealing layer is less than 1 μm, sealing force becomes low, which is undesirable. In contrast, if the thickness thereof is greater than 20 μm, sealing force may increase excessively, which is undesirable.

A better understanding of the present invention may be obtained through the following comparative examples and examples. However, the scope of the present invention is not limited to the examples or the substrate films used in the comparative examples and examples.

### EXAMPLE 1

A composite film resulting from laminating polyethyleneterephthalate (PET) having a thickness of 12 μm and nylon having a thickness of 12 μm was used. To enhance adhesion, an ethylenevinylacetate (EVA) layer having a thickness of 20 μm was formed on the PET side of the composite film using an extrusion coating process, thereby completing a substrate film for a cover tape comprising nylon/PET/EVA. As such, irregularities having a surface roughness of about 6 μm were formed on the EVA side.

Thereafter, an antistatic coating solution prepared by mixing poly(3,4-ethylenedioxythiophene) (PEDOT) and an acrylic binder was applied on both surfaces of the above film using a gravure coating process, and then dried, thus forming antistatic layers having a surface resistance of 10⁶ ohm/area.

An adhesive solution for forming a sealing layer was prepared by dissolving a styrene-ethylene-butylene-styrene copolymer (SEBS, styrene content: 30%) in toluene so as to have a solid content of 15 wt %. This adhesive solution was applied on the antistatic layer having surface irregularities using a slot die coating process, and then dried, thus forming a sealing layer having a thickness of about 5 μm and a width of 2 mm.

The resulting film was cut to a predetermined width, thereby manufacturing an antistatic cover tape (width: 21 mm) having the sealing layer (width: 1 mm) only on a sealing region.

The cover tape was sealed by heat and pressure to a polycarbonate carrier tape (width: 24 mm) having an antistatic layer composed mainly of a urethane binder and PEDOT as a conductive polymer and a surface resistance of 10⁵ ohm/area, and the cover tape was then peeled off to measure its peel strength. As such, the sealing was performed under conditions of a temperature of 170° C., a pressure of 0.34 MPa, and a sealing time of about 0.5 sec, and the peel strength was measured at a peeling rate of 300 mm/min.

Also, bare chips having an appropriate size were placed in the pockets of the carrier tape, and strongly shaken so that the bare chips in the pockets came into contact with the surface of the cover tape, after which whether the bare chips were efficiently detached was evaluated.

The peel strength of the cover tape thus manufactured was measured to be 57 g, and even when the bare chips in the pockets were shaken, they were not attached to the surface of the cover tape.

Also, the cover tape was sealed to the carrier tape and then allowed to stand at 60° C. for 72 hr, and the sealing region was then observed. As a result, there was no adhesion portion between the cover tape and the carrier tape, other than the sealing region. After aging testing, the peel strength was measured to be 81 g.

### EXAMPLE 2

Example 2 was the same as Example 1, with the exception that the antistatic coating solution applied on the EVA side of Example 1 was mixed with 5 wt % of silica particles having an average diameter of about 2 μm based on the solid content of PEDOT and acrylic binder so that surface irregularities were formed on the antistatic layer. As such, the average surface roughness (Ra) was measured to be about 1.5 μm.

The peel strength of the manufactured cover tape was measured to be 56 g, and the bare chips were not attached to the surface of the cover tape even when the bare chips in the pockets were shaken.

Also, the cover tape was sealed to the carrier tape, and allowed to stand at 60° C. for 72 hr, after which the sealing region was observed. As a result, there was no adhesion portion between the cover tape and the carrier tape, other than the sealing region. The peel strength after aging testing was measured to be 78 g.

### COMPARATIVE EXAMPLE 1

Comparative Example 1 was the same as Example 1, with the exception that silica particles were not added to the antistatic layer containing a conductive polymer as an effective component, and the composition of the adhesive solution for forming the sealing layer as in Example 1 was applied on the entire surface of the antistatic layer using a gravure coating process, and then dried, thus manufacturing a cover tape. Whereas the sealing layer was applied only on a predetermined region of the cover tape in Example 1, the sealing layer was applied on the entire surface in Comparative Example 1.

The peel strength of the cover tape was measured to be 55 g, which is similar to Example 1, but some of the bare chips were attached to the surface of the cover tape. Also, the cover tape was sealed to the carrier tape and then allowed to stand at 60° C. for 72 hr, after which the sealing region was observed. As a result, adhesion occurred on a portion other than the sealing region. The peel strength after aging testing was measured to be about 180 g, which is remarkably increased.

### EXAMPLE 3

Example 3 was the same as Example 2, with the exception that the adhesive solution for forming the sealing layer was prepared by dissolving a styrene-ethylene-butylene-styrene copolymer (SEBS, styrene content: 30%) in toluene to have a solid content of 15 wt % and then mixing 3 parts by weight of crosslinked polystyrene microbeads (diameter: 5 μm) based on 100 parts by weight of SEBS.

The cover tape was sealed to the polycarbonate carrier tape at 170° C., after which its peel strength was measured to be 53 g, and the bare chips placed in the pockets were not attached to the surface of the cover tape even when they were shaken.

Also, the cover tape was sealed to the carrier tape and then allowed to stand at 60° C. for 72 hr, after which the sealing region was observed. As a result, there was no adhesion portion between the cover tape and the carrier tape, other than the sealing region. The peel strength after aging testing was measured to be 58 g, which is not significantly changed.

### EXAMPLE 4

Example 4 was the same as Example 2, with the exception that a carrier tape composed of a polystyrene polymer was used, packaged semiconductor chips were used instead of bare chips, and the width of the cover tape was 25.4 mm.

The polystyrene-based carrier tape of the present example was an embossed carrier tape comprising a middle layer composed mainly of polystyrene as a polymer compound and a skin layer using a conductive compound made by mixing a polystyrene resin with about 30 wt % of conductive carbon black so as to exhibit a surface resistance of 10⁴ ohm/area.

The peel strength of the cover tape manufactured as in Example 2 was 68 g. Also, the semiconductor chips placed in the pockets were not attached to the surface of the cover tape even when strongly shaken.

### EXAMPLE 5

A composite film resulting from laminating 12 μm thick polyethyleneterephthalate (PET) and 12 μm thick nylon was used as a substrate film. Formed on the PET side of the composite film was a 20 μm thick ethylenevinylacetate (EVA) adhesion enhancing layer using an extrusion coating process, thus manufacturing a film comprising nylon/PET/EVA.

An antistatic coating solution comprising poly(3,4-ethylenedioxythiophene) (PEDOT) and an acrylic binder was applied on both surfaces of the film suing a gravure coating process, and then dried, thus forming antistatic layers having a surface resistance of 10⁶ ohm/area. As such, the antistatic coating solution applied on the EVA side was prepared by mixing 5 wt % of silica particles having an average diameter of about 2 μm based on the solid content of PEDOT and acrylic binder, so that surface irregularities were formed on the antistatic layer. As such, the average surface roughness (Ra) was measured to be about 1.5 μm.

The adhesive solution for forming the sealing layer was prepared by dissolving a styrene-ethylene-butylene-styrene copolymer (SEBS, styrene content: 30%) in toluene so as to have a solid content of 15 wt %. The adhesive solution was applied on the antistatic layer having surface irregularities using a slot die coating process, and then dried, thus forming a sealing layer having a thickness of about 5 μm and a width of 2 mm.

The film was cut to a predetermined width, thereby manufacturing an antistatic cover tape (width: 21 mm) having a sealing layer (width: 1 mm) formed only on the sealing region.

The cover tape was sealed by heat and pressure to a polycarbonate carrier tape (width: 24 mm) the surface of which was formed with an antistatic layer composed mainly of a urethane binder and PEDOT as a conductive polymer so as to have a surface resistance of 10⁵ ohm/area, and the cover tape was then peeled off to measure its peel strength. The sealing was performed under conditions of a temperature of 170° C., a pressure of 0.34 MPa, and a sealing time of about 0.5 sec, and the peel strength was measured at a peeling rate of 300 mm/min.

Also, bare chips having an appropriate size were placed in the pockets of the carrier tape, and strongly shaken so that the bare chips in the pockets came into the surface of the cover tape, after which whether the bare chips were efficiently detached was evaluated.

The peel strength of the manufactured cover tape was measured to be 56 g, and even when the bare chips in the pockets were shaken, they were not attached to the surface of the cover tape.

The cover tape was sealed to the carrier tape and then allowed to stand at 60° C. for 72 hr, after which the sealing region was observed. As a result, there was no adhesion portion between the cover tape and the carrier tape, other than the sealing region. After aging testing, the peel strength was measured to be 78 g.

### INDUSTRIAL APPLICABILITY

According to the present invention, a cover tape is useful for a carrier tape for transporting parts such as semiconductor IC chips, etc.

1. An antistatic cover tape for a carrier tape, comprising a sealing layer,
wherein the antistatic cover tape has irregularities having a size of 0.5˜50 μm at a surface portion which comes into contact with an object which is transported by the carrier tape, and
the sealing layer is formed on a portion which does not come into direct contact with the object which is transported.

2. The antistatic cover tape of claim 1, wherein the cover tape comprises a substrate film, an adhesion enhancing layer formed on the substrate film, an antistatic layer formed on the adhesion enhancing layer, and the sealing layer formed on a partial region of the antistatic layer, and
the irregularities are formed by making irregularities having a size of 0.5˜50 μm on a surface of the adhesion enhancing layer, introducing organic or inorganic particles having a size of about 0.5˜20 μm to the antistatic layer, or making irregularities having a size of 0.5˜50 μm on the surface of the adhesion enhancing layer and introducing organic or inorganic particles having a size of 0.1˜20 μm to the antistatic layer.

3. The antistatic cover tape of claim 2, wherein the surface of the adhesion enhancing layer is pressed using a roll having irregularities to form irregularities, and the particles contained in the antistatic layer are formed by using organic beads including styrene and acryl or inorganic particles including silica, titanium oxide, talc, calcium carbonate, alumina and zirconia, in an amount of 1˜100 parts by weight based on 100 parts by weight of a conductive polymer.

4. The antistatic cover tape of claim 3, wherein the antistatic layer having the irregularities is provided in a predetermined shape, including a mesh shape, a rectangular shape, a triangular shape, a polygonal shape, a circular shape, an oval shape or a star shape, on a partial region of a surface of the film.

5. The antistatic cover tape of claim 2, wherein the sealing layer contains a rubber-based adhesive as an effective component, and the rubber-based adhesive includes one or more selected from among natural rubber, butadiene rubber, ionomer rubber, styrene-butadiene (SBR), styrene-isoprene, styrene-butadiene-styrene (SBS), styrene-isoprene-styrene (SIS), and styrene-ethylene-butylene-styrene (SEBS).

6. The antistatic cover tape of claim 5, wherein the sealing layer comprises organic or inorganic particles, which include crosslinked styrene or acrylic microbeads, silica, titanium oxide, talc, calcium carbonate, alumina, and zirconia particles and are used in an amount of 0.5˜10 parts by weight based on 100 parts by weight of the rubber-based adhesive.

7. The antistatic cover tape of claim 2, wherein the antistatic cover tape is used for a carrier tape including a pocket for receiving a transport object and sprocket holes, and the sealing layer is formed in a range of 10˜90% of a width of a sealing region ranging from a pocket wall of the carrier tape to an edge of the carrier tape, except for a portion having the sprocket holes.

8. The antistatic cover tape of claim 7, wherein the substrate film for the antistatic cover tape is, as a transparent or translucent substrate film, a monolayer film or a multilayer film having two or more layers comprising a polymer having any one of functional groups including an ester group, a carbonate group, a styrene group, an amide group, an imide group, an ether group, an olefin group and a sulfone group, or a polymer having an alloy or blend of two or more of the functional groups.

9. The antistatic cover tape of claim 7, wherein the substrate film for the antistatic cover tape is a two-layered film comprising two kinds of different films which are laminated, in order to prevent curling.

10. The antistatic cover tape of claim 7, wherein the antistatic cover tape includes the adhesion enhancing layer, and the adhesion enhancing layer is formed of a styrene-based resin or copolymer, an amide-based resin or copolymer, or an olefin-based copolymer including ultra low density polyethylene or ethylenevinylacetate.

11. The antistatic cover tape of claim 7, wherein the antistatic cover tape includes the antistatic layer, and the antistatic layer is formed using a conductive polymer having a functional group including aniline, pyrrole or thiophene, or a derivative thereof, as an effective component.

12. The antistatic cover tape of claim 3, wherein the sealing layer contains a rubber-based adhesive as an effective component, and the rubber-based adhesive includes one or more selected from among natural rubber, butadiene rubber, ionomer rubber, styrene-butadiene (SBR), styrene-isoprene, styrene-butadiene-styrene (SBS), styrene-isoprene-styrene (SIS), and styrene-ethylene-butylene-styrene (SEBS).

13. The antistatic cover tape of claim 12, wherein the sealing layer comprises organic or inorganic particles, which include crosslinked styrene or acrylic microbeads, silica, titanium oxide, talc, calcium carbonate, alumina, and zirconia particles and are used in an amount of 0.5˜10 parts by weight based on 100 parts by weight of the rubber-based adhesive.

14. The antistatic cover tape of claim 3, wherein the antistatic cover tape is used for a carrier tape including a pocket for receiving a transport object and sprocket holes, and the sealing layer is formed in a range of 10˜90% of a width of a sealing region ranging from a pocket wall of the carrier tape to an edge of the carrier tape, except for a portion having the sprocket holes.

15. The antistatic cover tape of claim 14, wherein the substrate film for the antistatic cover tape is, as a transparent or translucent substrate film, a monolayer film or a multilayer film having two or more layers comprising a polymer having any one of functional groups including an ester group, a carbonate group, a styrene group, an amide group, an imide group, an ether group, an olefin group and a sulfone group, or a polymer having an alloy or blend of two or more of the functional groups.

16. The antistatic cover tape of claim 14, wherein the substrate film for the antistatic cover tape is a two-layered film comprising two kinds of different films which are laminated, in order to prevent curling.

17. The antistatic cover tape of claim 14, wherein the antistatic cover tape includes the adhesion enhancing layer, and the adhesion enhancing layer is formed of a styrene-based resin or copolymer, an amide-based resin or copolymer, or an olefin-based copolymer including ultra low density polyethylene or ethylenevinylacetate.

18. The antistatic cover tape of claim 14, wherein the antistatic cover tape includes the antistatic layer, and the antistatic layer is formed using a conductive polymer having a functional group including aniline, pyrrole or thiophene, or a derivative thereof, as an effective component.

19. The antistatic cover tape of claim 5, wherein the antistatic cover tape is used for a carrier tape including a pocket for receiving a transport object and sprocket holes, and the sealing layer is formed in a range of 10˜90% of a width of a sealing region ranging from a pocket wall of the carrier tape to an edge of the carrier tape, except for a portion having the sprocket holes.

20. The antistatic cover tape of claim 6, wherein the antistatic cover tape is used for a carrier tape including a pocket for receiving a transport object and sprocket holes, and the sealing layer is formed in a range of 10˜90% of a width of a sealing region ranging from a pocket wall of the carrier tape to an edge of the carrier tape, except for a portion having the sprocket holes.
